(19) United States
(12) Patent Application Publication
(10) Pub. No.: US 2026/0307012 A1
(43) Pub. Date: Oct. 8, 2026

(54) SALT-REJECTING CONTINUOUS PASSIVE SOLAR THERMAL DESALINATION VIA THIN-FILM CONDENSATION

(71) Applicant: The Regents of the University of California, Oakland, CA (US)

(72) Inventors: Yangying Zhu, Santa Barbara, CA (US); Patrick Ian Babb, II, Chino Hills, CA (US)

(73) Assignee: The Regents of the University of California, Oakland, CA (US)

(21) Appl. No.: 19/482,462

(22) PCT Filed: May 13, 2024
(86) PCT No.: PCT/US2024/029058

§ 371 Date: Nov. 7, 2025

Related U.S. Application Data
(60) Provisional application No. 63/502,032, filed on May 12, 2023.

(51) Int. Cl. B01D 61/36; B01D 1/00; B01D 5/00; B01D 69/02; C02F 1/44; C02F 103/08

(52) U.S. Cl. CPC B01D 61/366; B01D 1/0035; B01D 5/006; B01D 61/364; B01D 69/02; C02F 1/447; B01D 2313/221; B01D 2325/36; C02F 2103/08

(57) ABSTRACT

A method and system for distilling, comprising a continuous single stage or multi stage process irradiating an evaporator in a presence of liquid comprising a material through a transparent cover under conditions wherein the evaporator converts the solar radiation to heat evaporating the liquid, so as to form vapor and a liquid having a higher concentration of the material; discharging the liquid having the higher concentration under conditions wherein an amount of material in the evaporator reaches equilibrium over time, as opposed to continuously increasing; and condensing the vapor in the condenser to form a condensed liquid. In the multi stage configuration latent heat released from the condensed liquid from the prior stage is reused for additional next stage vaporization of liquid comprising a material.

### CROSS REFERENCE TO RELATED APPLICATIONS

This application claims the benefit under 35 U.S.C. Section 119(e) of the following co-pending and commonly-assigned application:

U.S. Provisional Application Ser. No. 63/502,032, filed on May 12, 2023, by Yangying Zhu and Patrick Babb, entitled “SALT-REJECTING CONTINUOUS PASSIVE SOLAR THERMAL DESALINATION VIA THIN-FILM CONDENSATION,” attorneys' docket number G&C 30794.0837USP1 (UC 2023-889-1);

which application is incorporated by reference herein.

### STATEMENT REGARDING FEDERALLY SPONSORED RESEARCH AND DEVELOPMENT

This invention was made with Government support under 2047727 awarded by the National Science Foundation. The Government has certain rights in this invention.

### BACKGROUND OF THE INVENTION

### 1. Field of the Invention

The present invention relates to devices comprising one or more evaporators and condensers (e.g., distiller) and methods of making and implementing the same.

### 2. Description of the Related Art

(Note: This application references a number of different publications as indicated throughout the specification by one or more reference numbers in superscripts. A list of these different publications ordered according to these reference numbers can be found below in the section entitled “References.” Each of these publications is incorporated by reference herein.)

Water and energy are among the greatest challenges of the 21st century, yet current industrial-scale desalination technologies including reverse osmosis and distillation are still energy-intensive.¹ Solar thermal desalination is an attractive passive technology where sunlight is utilized as heat to vaporize water² which can then be condensed to pure liquid water. These devices are potentially cost-effective and portable, making them suitable for developing countries where water scarcity is most severe.³ So far, most reports have focused on engineering solar-absorbing porous materials to localize solar heat to the liquid-vapor interface.⁴⁻¹¹ Highly-efficient evaporation can be achieved by avoiding heating the bulk of water and minimizing conduction, convection, and radiation heat loss. Solar-to-vapor efficiency, usually defined as the total latent energy required to produce a certain mass of vapor over the input sunlight,¹² exceeding 90% has been demonstrated under concentrated and one sun conditions.¹⁰

Despite the advancements in evaporator development, only a few reports have incorporated condensation, which is a necessary step to convert water vapor back to liquid water, into their desalination systems.¹³⁻¹⁸ Most of these full systems have an inverted design, where the condenser is below the evaporator to avoid blocking the sunlight. To reduce the thickness of liquid in the evaporator, several inverted systems employed a thin wicking layer to feed salt water using capillarity to the solar absorber for evaporation. The minimum amount of water in the wicking layer significantly reduced heat loss. As such, solar-to-water efficiency as high as 70% has been demonstrated under one sun for single-stage devices, and even higher solar-to-water efficiencies are achieved with multi-stage devices. Solar-to-water efficiency is evaluated using the mass of collected liquid water as opposed to the mass of the evaporated water vapor in the solar-to-vapor efficiency. However, the wicking mechanism inherently lacks a salt rejecting mechanism, therefore, the high efficiencies are mainly demonstrated with pure water. With salt water, salt crystals were observed on the evaporator as soon as two hours after being exposed to sunlight.¹⁵ Several recent salt-rejecting designs utilized a contactless absorber⁸ and salt diffusion^{8,15,19}, yet most of these systems only have the evaporator with no condenser. A full system with a salt rejection mechanism that allows continuous desalination without efficiency decay is highly desirable.

Furthermore, most reports incorporated dropwise condensation on hydrophobic surfaces. While dropwise condensation has a higher heat transfer coefficient than the conventional film-wise condensation, it relies on a hydrophobic coating which has been known to suffer from durability issues. Dropwise condensation also relies on gravity to remove the condensed drops and therefore cannot be positioned horizontally. In fact, several studies reported droplets stuck to the condenser surface which reduced the amount of collected liquid.^{14,15} In addition, efficient vapor transport from the evaporator to the condenser is also critical to ensure a high solar-to-water efficiency. This requires a minimal gap distance between the evaporator and the condenser surface, assuming that there is sufficient thermal isolation between the evaporator and the condenser. This is difficult to achieve with condenser surfaces that are not parallel to the evaporator.

What is needed, then, are more efficient and robust desalinators or distillers. The present invention satisfies this need.

### SUMMARY OF THE INVENTION

Embodiments of the present invention comprise a passive inverted single stage or multi stage solar membrane desalinator or distiller that achieves continuous desalination/distillation and salt rejection with a novel architecture. By flowing salt water on a radiative absorbing, porous, hydrophobic evaporator membrane using gravity, salt continuously diffuses away from the membrane while allowing heated gaseous water vapor to transport to and condense on a cooler microporous membrane below. In addition, the design utilizes thin-film condensation on a microporous membrane which offers ample three-phase contact region to enhance condensation phase change heat transfer. Thin-film condensation refers to condensation process occurring near the liquid-vapor-solid contact region, where the solid needs to be a high-thermal-conductivity material allowing heat released during condensation to be conducted away easily. By condensing within the microporous membrane instead of forming droplets, the gap distance between the condenser and evaporator membranes is reduced, which effectively reduces the vapor transport resistance. The single stage embodiment experimentally demonstrated a record-high continuous desalination and salt rejection test duration of 7 days under one-sun illumination, while conventional state of the art devices demonstrated 12 hours of continuous desalination due to salt accumulation on the wicking evaporator. Despite an increased convection heat loss necessary for salt rejection on the evaporator, the desalinator presented herein still achieved a water-collection rate of 0.5 kg m⁻² h⁻¹, which corresponds to a 32.9% solar to water efficiency. This work signifies an improvement in the robustness of current state of the art desalinators and presents a new architecture to further optimize passive solar desalinators. In addition, a multistage embodiment has also been developed where the latent heat released at the previous-stage condenser is conducted to the next-stage evaporator and reused for additional vaporization at a next-stage evaporator. This embodiment allows the existence of many evaporators and condensers in series combined to make a multistage device.

Although embodiments of the present invention have been illustrated with desalination, devices according to the present invention can also be used to extract materials from liquid generally through the distillation or evaporative process.

### BRIEF DESCRIPTION OF THE DRAWINGS

Referring now to the drawings in which like labels represent corresponding parts throughout:

FIG. 1. Design of the distilling (e.g., single-stage salt-rejecting desalination concept, or concept of removing material from a liquid by evaporation). (a) Cross section drawing of the device (e.g., desalination design) and transport mechanisms. (b) Schematic shows the passive salt-rejecting desalination device is composed of a top evaporator and a bottom aluminum condenser. The path of the fluid flow is indicated by a blue arrow, wherein the water enters through the inlet and travels over the evaporator, and finally exits through the outlet. In addition, an efficient thermal connection is established through copper, allowing the warm water leaving the outlet to preheat the cool water entering the inlet, further optimizing the desalination process. (c-e) Present optical images of the device, providing visual representations of its components and structure. (c) The assembled device, featuring the evaporator and condenser elements, and a top optically transparent film. (d) A bottom view of the hydrophobic, microporous, solar absorptive evaporator. One possible embodiment of the evaporator is a gas diffusion layer (GDL) as the evaporator membrane covered with black carbon nanoparticles. (e) A top view of the condenser with a white hydrophilic membrane on top.

FIG. 2. Characterization of optical properties and vapor production of the evaporator. (a) Scanning electron microscopy (SEM) image of the GDL substrate alone. (b) SEM image of the evaporator membrane composed of the GDL substrate coated with PDMS and carbon black nanoparticles. (c) Optical image of the microporous paper condenser membrane. (d) Optical image of the nickel foam. (e) Absorptivity of the evaporator membrane using the UV-Vis-NIR spectrophotometer. (f) Transmittance spectra of the ETFE and PETG films used as a transparent cover and divider respectively. (g) Vapor production from the evaporator membrane is 4.67 g h⁻¹ corresponding to 0.73 kg m⁻² h⁻¹. The inset figure illustrates the evaporator used without the condenser to measure the vapor flux. Experiments in (g) were conducted in a room with an average temperature and relative humidity of 20° C. and 54%, respectively.

FIG. 3. Comprehensive 7-day performance analysis of the device utilizing saline seawater and solar flux. The assessment encompassed two distinct approaches, namely, fully passive gravity-driven water container testing (a and b) and controlled flow rate via a syringe pump (c and d). (a) Inlet seawater salinity recorded at 3.15 wt %. The average inlet flow rate over the duration of the test was 7 g h⁻¹. (b) During the full passive gravity-driven water container testing, the experiment entailed continuous monitoring of the mass rate (pink data points in a) and corresponding temperatures of the ambient, condenser, and evaporator (b). The fully passive experiment was conducted in a laboratory setting with an average temperature of T_{amb}=23° C. and a relative humidity of RH≈54%. (c) The experiment involved a saltwater inlet flow rate of 5 mL h⁻¹. (d) During the experiment, the corresponding temperatures of the ambient, condenser, and evaporator were observed and recorded. The experiment was conducted in a laboratory setting with an average temperature of T_{amb}=21° C. and relative humidity of RH≈60%. The results of the experiment are compared with the theoretical model, represented by the black dashed line in (a) and (c). In addition, a linear fit to the experimental data points is shown as the black dotted line in (a) and (c). The laboratory test setups are depicted schematically in insets in (a) and (c).

FIG. 4. Energy flow to unveil the theoretical solar-to-water efficiency for a single-stage device. (a) The equivalent thermal resistance network for a single-stage device. (b) Schematic of the cross-section of the device and energy flow. (c) The relationship between solar-to-water efficiency and the gap between the evaporator and condenser (d) and natural heat transfer coefficient on top of the top transparent cover (e) and the natural heat transfer coefficient on the bottom of the aluminum surface is examined with an assumed ambient temperature of 20° C.

FIG. 5. Comparative analysis between experimental and analytical predictions of the 1-day continuous experiment utilizing a gravity-driven water container and fans setup.

Air velocity regulation beneath the condenser was achieved using two identical 4×4 cm fans. The experiment was conducted in a controlled environment with an average temperature of Tamb≈23° C. and a relative humidity of RH≈60%. In (a) the continuous experimental distillate production over time is depicted by the pink data points, revealing a collection rate of 3.83 g h⁻¹ (92 g day⁻¹). The orange region, bounded by two lines (dashed and solid), illustrates theoretical predictions for varying convective heat transfer coefficients from 20 (dashed line; η=37.5%) to 50 W m⁻² K⁻¹ (solid line; η=43.7%). Corresponding temperatures of the laboratory, condenser, and evaporator are recorded and plotted in (b).

FIG. 6. Flowchart illustrating a method of making a device.

FIG. 7. Method of operating a device.

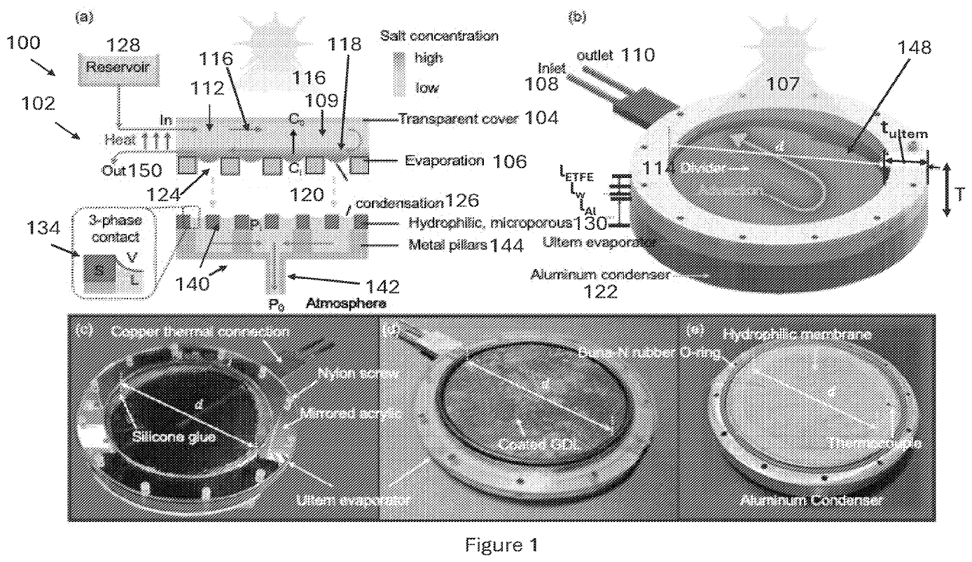

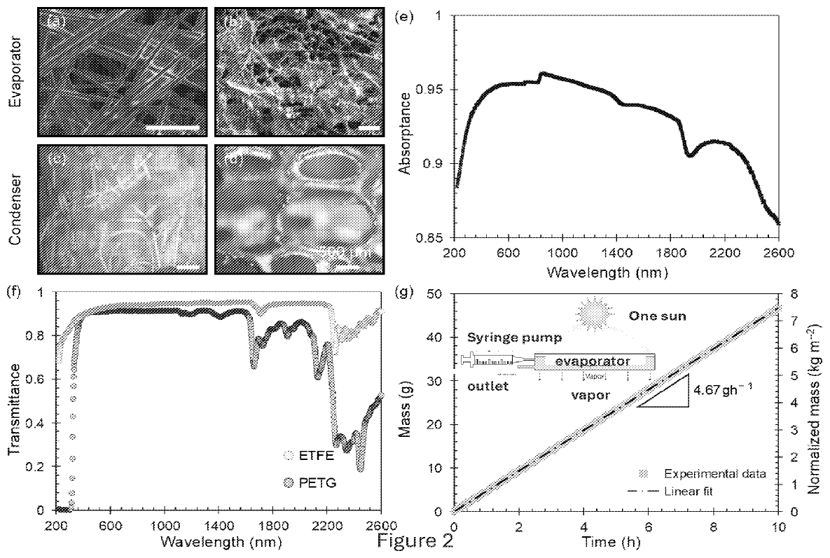

FIG. 8. Cross section drawing of the device in the multistage configuration (e.g., desalination design) and transport mechanisms. There is minimal thermal resistance (via a metal structure) from the previous-stage condenser to the next-stage evaporator to fully reutilize latent heat. This latent heat or condensed heat reuse in the multistage device differentiates it from the single stage configuration seen in FIG. 1a.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

FIG. 1 illustrates a device according to one or more embodiments of the present invention. The device comprises an evaporator comprising a transparent cover; a hydrophobic, porous, and heat absorbing evaporator membrane; an inlet for receiving a liquid (e.g., comprising or containing one or more materials); an outlet; a space between the evaporator membrane and the transparent cover; and a divider in the space dividing a flow of the liquid. The divider is configured to maintain a bulk flow of the liquid around the divider and closer to the transparent cover, and a thinner layer of the liquid on a surface of the membrane.

In operation, the evaporator membrane absorbs the solar radiation transmitted through the transparent cover to form heat evaporating the liquid to form a vapor, wherein the evaporating increases a local concentration of the materials (e.g., non evaporated components left behind) in the thinner layer of the liquid, and the divider allows mixing of the thinner layer with the bulk flow around the divider through advection, so that the material(s) diffuse from the thinner layer to the bulk flow. The outlet discharges the liquid in the thinner layer having higher concentration of the materials. This discharge mechanism allows the amount of the materials (non evaporated components) within the evaporator to reach equilibrium over time, as opposed to continuously increasing in a wick structure. However, it will inevitably increase heat loss on the evaporator due to natural convection within the water layer.

FIG. 1 further illustrates a condenser, coupled below the evaporator for receiving the vapor transmitted through the pores into the evaporator membrane. The condenser condenses the vapor to form a condensed liquid. The condenser is typically a microporous or nanoporous condenser membrane for highly efficient thin-film condensation. In contrast to conventional drop-wise and film-wise condensation on a solid surface where droplets condense and shed on the same side of the surface, the vapor condenses on the front side of the condenser membrane and the condensed liquid is collected from the backside. In this way, the condenser membrane can theoretically be placed extremely close to the evaporator membrane, allowing minimal vapor transport resistance. Analogous to thin-film evaporation from micro/nanostructures, which achieves the highest phase change heat transfer coefficient, thin-film condensation in the microporous condenser membrane allows abundant three-phase contact region (FIG. 1) and can therefore potentially achieve higher condensation heat transfer coefficient compared to drop-wise condensation. Furthermore, the condenser membrane is hydrophilic and capillary pressure was utilized to lower the local liquid pressure, promoting the condensed liquid to spontaneously enter the backside of the membrane, and preventing accumulation of liquid on top of the membrane. This low pressure can be created simply via a hydrostatic pressure between the membrane and the outlet of the condensed liquid.

### Example Device Comprising Single Stage Desalinator

a. Structure

The single stage desalinator consists of three primary components: the reservoir, the evaporator and the condenser, as shown in FIG. 1a. Liquid flows from the reservoir into the evaporator driven by gravity. A transparent cover transmits sunlight to a microporous solar-absorbing and hydrophobic evaporator membrane. Salt water is sandwiched between the transparent cover and the evaporator membrane. One embodiment of the evaporator membrane was fabricated by coating carbon black nanoparticles onto a commercially available gas diffusion layer (GDL) using polydimethylsiloxane (PDMS) with curing agent as the binder (FIGS. 2a-b). The GDL is a fibrous, Teflon treated carbon paper with a porosity of 78%.²¹ Two copper tubes serve as the water inlet and outlet of the evaporator in order to maintain a salt concentration in the evaporator chamber below saturation. The copper tubes are thermally connected so that exiting warm water preheats the incoming cool water to recover thermal energy. Above the evaporator there is a polyethylene terephthalate glycol (PETG) divider to separate the inlet from the outlet such that liquid will flow across the entire evaporator membrane before being discharged (FIG. 1b).

The evaporator and condenser are separated by a thin air gap which allows efficient vapor transport from the evaporator to the condenser while still maintaining a temperature difference. A thinner gap distance reduces the vapor transport resistance which is modeled using the Fick's law but may increase the heat conduction from the evaporator to the condenser. In addition, as the temperature of the water above the evaporator increases, the solubility of air in the water decreases which can cause air bubbles to form on the evaporator membrane. In order to mitigate this problem, a small opening is introduced between the evaporator and condenser to allow air to vent. The condenser membrane is a hydrophilic microporous material. which provides ample three-phase contact area for effective condensation. To reject heat, the microporous material is supported by thermally conductive structures, where heat is dissipated to the environment through convection.

b. Characterization

### (i) Evaporator Structure and Absorptivity

In an one example embodiment of the evaporator we characterized the optical property of the membranes and films through Ultraviolet-Visible-Near-Infrared (UV-Vis-NIR) spectrophotometry. FIG. 2e shows that the evaporator membrane has an absorptivity greater than 0.9 for the majority of the solar spectrum between 200 nm and 2.6 μm and an absorptivity greater than 0.85 for the solar spectrum between 200 nm and 2.6 μm. This result shows that the evaporator membrane is absorbing the vast majority of incoming solar light and heating since about 99% of solar radiation is contained in the region between 300 nm to 3 μm.²³ FIG. 2f illustrates that ETFE, the transparent cover for the device, has a transmittance of greater than 0.9 for the majority of the spectrum between 200 nm and 2.6 μm, which allows for high solar transmission to the membrane. Since the layer of water sandwiched between the evaporator and ETFE is thin (~1 mm), we estimate that less than 80% of the incoming solar energy is used to heat the evaporator membrane. The thickness of water increases to 5 mm at the inlet and outlet to allow water from the copper tubes to enter the desalinator freely. The divider has a lower transmittance than ETFE that declines after 1.5 μm however the divider is only exposed to a negligibly small portion of the evaporator membrane.

### (ii) Device Operation Characterization

### Methods

Before testing the full system, the liquid to vapor efficiency of the evaporator was first characterized under a solar simulator (Newport ORIEL SOL3A) with continuous solar flux of 1000 W m⁻² (one sun) for 10 hours. The device has only the evaporator which evaporates water into ambient air (inset, FIG. 2g). The diameter of the exposed evaporator membrane is 9 cm. We used salt water obtained from Goleta Beach in California. The salinity was 2.90 wt %, measured using an ORAPXI digital salinity tester (PS-A200). In order to estimate an upper limit of the solar to vapor efficiency corresponding to a minimal liquid flow rate, we used a syringe pump to supply salt water to the evaporator and gradually reduced the flow rate until the flow rate of the discharged water was negligibly low. At this condition, the inlet flow rate was 4.9 mL h⁻¹ and the discharged flow rate was measured to be 0.18 mL h⁻¹. The mass of the evaporated liquid over time shown in FIG. 2g was calculated by subtracting the mass of the discharged water measured using a mass balance from the mass of the supplied liquid. Although this discharge flow rate may be too low to avoid salt precipitation on the evaporator membrane over an extended period of time, the salinity of sea water on the evaporator after the 10 hour test concluded was 3.32 wt %, well below the saturation concentration of 26.89 wt %. This saturation concentration is evaluated at 50° C., which was roughly the evaporator temperature.²⁴ No salt precipitation was observed on the evaporator membrane immediately after the experiment.

As seen in FIG. 2g, the evaporator membrane alone has a vapor production rate of 4.67 g h⁻¹ or 0.73 kg m⁻² h⁻¹ corresponding to a solar to vapor efficiency of 49.1%. We chose the latent heat at 50° C., because this is the approximate evaporator temperature we observed in subsequent experiments using the same evaporator membrane and ETFE transparent film. The incoming solar flux is 1000 W m⁻² (one sun). Only latent heat, not sensible heat is considered in order to provide a conservative solar to vapor efficiency result. The majority of heat is lost through natural and forced convection in the thin liquid layer on top of the membrane. The definition of efficiency is

$$η = \frac{\dot{m} {h}_{fg}}{{q}_{solar} {A}_{0}} \qquad ( 1 )$$

where \dot{m} is the mass flow rate of distillate collected, h_{fg} is the latent heat of vaporization.

Full system tests containing the evaporator and the condenser lasting 7 days using salt water from Goleta Beach in California were conducted. The tests were performed under one sun condition using the solar simulator. The measured salinity of salt water was 3.15%.

### Results

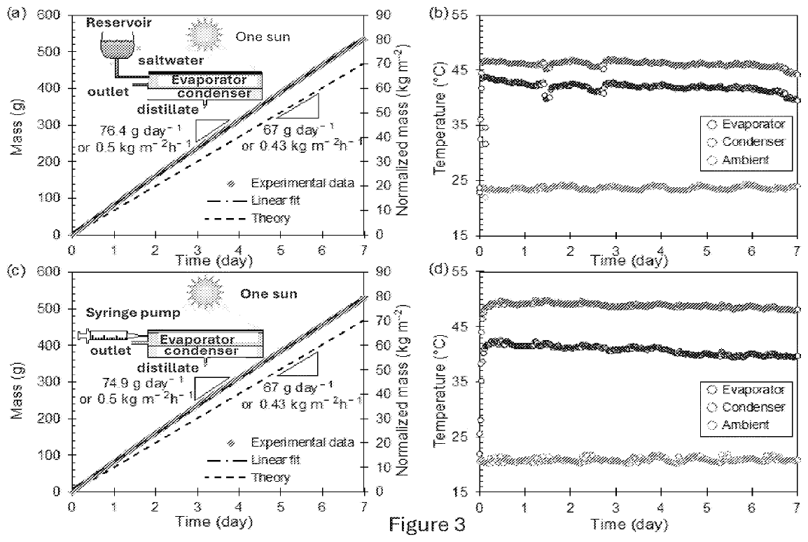

In FIG. 3a, the rate of fresh water collection does not decay even after 7 days (168 h) of continuous operation under one sun illumination, which indicates that the pore sizes of the evaporator membrane possibly remained unchanged and we further hypothesize that no salt crystals were formed. As seen in FIG. 3a, we achieved a distillate production rate of 76.4 g day⁻¹, which corresponds to 0.497 kg m⁻² h⁻¹ over 7 days in one sun using the passive method and a 32.9% solar-to-water efficiency. The experimental efficiency is in line with our model where we obtained a 0.43 kg m⁻² h⁻¹ production rate corresponding to a 28.9% efficiency. The temperatures of the evaporator and the condenser membranes are shown in FIG. 3b. Throughout the duration of the 7-day experiment, the mean temperatures for the condenser, evaporator, and ambient environment were ascertained to be, Tc≈42° C., Te≈46° C., and T_{amb}≈23° C., respectively. In addition, we performed inductively coupled plasma analysis on the distillate and found that the ion concentrations in the distillate were below the WHO health guideline and taste threshold as well.

A 7-day desalination experiment was conducted, wherein a syringe pump was utilized to ensure a consistent flow rate of 5 mL h⁻¹, serving as a control experiment. The full system consists of the evaporator and the condenser. The flow rate of 5 mL h⁻¹ was determined to be sufficient in avoiding salt precipitation as the concentration of discharged salt water from the outlet was 5.60 wt % after 7 days, which was lower than the saturation salt concentration of 26.889 wt %. FIG. 3C illustrates the distillate production as a function of time. We achieved a distillate production rate of 74.9 g day⁻¹ or 0.487 kg m⁻² h⁻¹ which corresponds to an efficiency of 32.0%. This efficiency is similar to the efficiency of the 7-day passive test, which suggests that the efficiency is relatively insensitive to changes in the flow rate for the conditions that we tested. The measured salinity of the distillate was also 0.00 wt %. FIG. 3d demonstrates temperatures of the evaporator membrane, condenser membrane as well as the ambient temperature of the laboratory during the 7-day experiment. Throughout the duration of the 7-day experiment, the mean temperatures for the condenser, evaporator, and ambient environment were ascertained to be Tₑ≈41° C., Tₑ≈49° C., and T_{amb}≈21° C., respectively.

### Model Simulation Framework for the Example Device Characterized Herein (See Ref. (35) for Further Details)

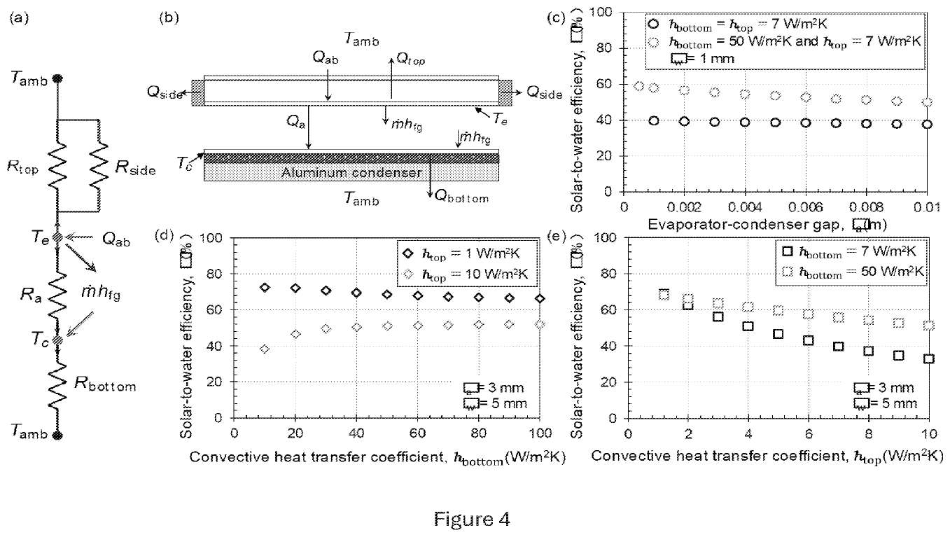

FIGS. 4a and 4b show an equivalent thermal resistance network and the energy flow of the system, respectively. Under heat and mass transfer at steady-state conditions, the evaporator absorbs heat from the sunlight Q_{ab}=τ_{f}αₐqₛₒₗₐᵣ A₀, where τ_{f} is the transmittance of the ETFE film, and αₐ is the absorptance of the evaporator membrane, and absorber area A₀. Evaporation occurs on the membrane, which removes heat \dot{m}h_{fg} from the evaporator membrane, where \dot{m} is the mass flow rate of vapor production (kg/s) and h_{fg} is the latent heat of vaporization. The evaporator loses heat through the top surface Oₜₒₚ, through the side Ultem Q_{side}, and through the air gap to the condenser Qₐᵢᵣ. The sensible heat loss from the discharged salt water is neglected by assuming effective heat recycling due to the counter-flow heat exchanger. Heat conduction through the O-ring from the evaporator to the condenser is neglected due to its minimal contact area with the membranes. The vapor condenses on the condenser membrane, which releases the same amount of latent heat \dot{m}h_{fg} on the condenser membrane. The condenser membrane also receives heat from the evaporator through heat conduction across the air gap Qₐᵢᵣ, and rejects heat to the ambient via the aluminum Q_{bottom}.

In the equivalent thermal resistance network, balancing the heat gain and heat loss at the evaporator membrane (Tₑ) and condenser membrane (T_{c}) requires

$${Q}_{ab} - \frac{{T}_{e} - {T}_{amb}}{{R}_{top}} - \frac{{T}_{e} - {T}_{amb}}{{R}_{side}} - \frac{{T}_{e} - {T}_{c}}{{R}_{a}} - \dot{m} {h}_{fg} = 0 , \qquad ( Equation 2 )$$

$$\dot{m} {h}_{fg} + \frac{{T}_{e} - {T}_{c}}{{R}_{a}} - \frac{{T}_{c} - {T}_{amb}}{{R}_{bottom}} = 0. \qquad ( Equation 3 )$$

In Equations 2 and 3, Tₑ, T_{c}, and T_{amb} are temperatures of the evaporation interface (or the evaporator membrane), the condensation interface (or the condenser membrane), and the ambient. Rₜₒₚ, R_{side}, Rₐ, and R_{bottom} are the total thermal resistances

and defined as R=ΔT/Q for Qₜₒₚ, Q_{side}, Qₐᵢᵣ, and Q_{bottom}, The thermal resistances are only functions of the geometry and the thermal conductivity of the materials in the device, and the air convection heat transfer coefficient on the external surface of the device. Furthermore, vapor transport between the evaporator and the condenser is governed by Fick's diffusion law,^{48,49}

$$\dot{m} = {A}_{0} D [ \frac{{c}_{sat} ( {T}_{e} ) - {c}_{sat} ( {T}_{c} )}{{t}_{a}} ] \qquad ( Equation 4 )$$

where D is the diffusivity of water vapor in air and cₛₐₜ is the saturation vapor mass concentration. Equations 2, 3, and 4 have three unknowns: Tₑ the evaporator membrane temperature, T_{c} the condenser membrane temperature, and \dot{m} the mass flow rate, which is equal to the distillate production rate at steady state.

We calculated the numerical solutions of Tₑ, T_{c}, and \dot{m}, (see 35) which will be validated using our experimental data. The model can be used to provide a detailed investigation into the impact of various design parameters on the solar-to-water efficiency. Rside is calculated in COMSOL as R_{side}=33.3 K/W (35), as well as the rest of the thermal resistances (35). Using the thermophysical properties of Table S1 in (35) and an air convection heat transfer coefficient of 10 W m⁻² K⁻¹ on the bottom and top surfaces of the device, the numerical solution of Equations 2, 3, and 4 in MATLAB yields T_{c}=51.65° C. and Tₑ=54.67° C., which are in a great agreement with the experimental results (FIGS. 3B and 3D). In addition, the solar-to-water efficiency calculated using Equation 1 is found to be 28.87%. These results are in excellent agreement with the experimentally observed values. Finally, a great agreement with only a 12% discrepancy has been observed between the theoretical mass rate (black dashed lines in FIGS. 3A and 3C) and the experimental data (pink data points). Note that the ambient temperature was set to 20° C. and the mass diffusivity of water vapor in air was determined using Chapman-Enskog theory as part of the analysis process.

The model framework was used to investigate the influence of different parameters on the optimization of solar-to-water efficiency. The thermophysical properties are based on Table S1 in (35). It is worth noting that, for the purpose of our analysis, the calculation is for a scaled-up device such that A₀>>A_{side}. Therefore, Q_{side} is negligible and we did not include the (Tₑ−T_{amb})/R_{side} term in Equation 2. By excluding Q_{side} from our calculations, we obtained the results and conclusions presented in FIGS. 4C-4E.

FIGS. 4c-4e illustrate the effects of various parameters on the solar-to-water efficiency, including the evaporator-condenser gap (tₐ) and air convective heat transfer coefficients on the bottom surface of the condenser (h_{bottom}) and the top surface of the transparent film (hₜₒₚ). As illustrated in FIG. 4c, the system's efficiency decreases as the gap size between the evaporator and condenser increases. This phenomenon is primarily attributed to the elevated vapor transport resistance, which arises due to the expanded gap size between the two components. The impact of this decrease is more pronounced when there is a larger value (h_{bottom}=50 W m⁻² K⁻¹) of convective heat transfer coefficient at the bottom of the condenser.

We then examined the influence of the condenser total thermal resistance on the efficiency (FIG. 4d) by varying h_{bottom}. For a natural air convective boundary condition on the top (hₜₒₚ=10 W m⁻² K⁻¹), increasing h_{bottom} results in an increase in the efficiency. This is because when the total thermal resistance on the condenser side is decreased by increasing h_{bottom}, heat dissipation from the condenser to the environment is enhanced. Therefore, temperatures of the evaporator and the condenser are reduced, which decreases heat loss and enables better utilization of solar energy to evaporate water. As a result, the overall efficiency of the system improved, maximizing its ability to convert solar energy into usable heat for water heating purposes. These observations have been experimentally verified and validated through our modeling efforts (see the “Model validation via convective cooling experiment” section). Interestingly, as shown in FIG. 4d, the efficiency reached a plateau at approximately h_{bottom}≈30 W m⁻² K⁻¹. If we thermally insulate the top surface of the evaporator by setting hₜₒₚ=1 W m⁻² K⁻¹, the solar-to-water efficiency of the system is much higher (>70%). This is because heat loss on the evaporator is suppressed. Interestingly, the efficiency for hₜₒₚ=1 W m⁻² K⁻¹ is relatively insensitive to h_{bottom}, and even decreases slightly, possibly due to minor uncertainty in the empirical vapor concentration equation. A maximum solar-to-water efficiency of 72.5% was achieved when hₜₒₚ=1 W m⁻² K⁻¹. In an ideal scenario where the total solar energy is fully absorbed by the membrane and the transmittance of the top cover is 100% (Q_{ab}=qₛₒₗₐᵣ), the efficiency could further increase to 90%. The importance of thermal insulation on the evaporator side is also shown in FIG. 4e, where reducing hₜₒₚ contributed to an increase of the efficiency. To enhance the system's overall performance and reduce energy losses during the conversion process, optimizing the top cover's transmittance, the evaporator membrane's absorptance, increasing the total thermal resistance on the top of the evaporator, and reducing the condenser's thermal resistance to the ambient air are crucial factors. These adjustments play a significant role in increasing the solar-to-water efficiency and maximizing the utilization of solar energy for water heating.

### Model Validation Via Convective Cooling Experiment

To further validate the model for regimes with enhanced convective heat transfer coefficient on the condenser surface, we conducted an additional controlled experiment that is detailed in (35). The experiment involved a v1-condenser equipped with fins, referred to as v3-condenser, along with two side-by-side fans to increase the convective heat transfer coefficient. The experimental duration extended over 1 day to evaluate the desalination performance. Impressively, the results showcased outstanding consistency between the theoretical predictions and experimental findings, with a mere 5% error rate/

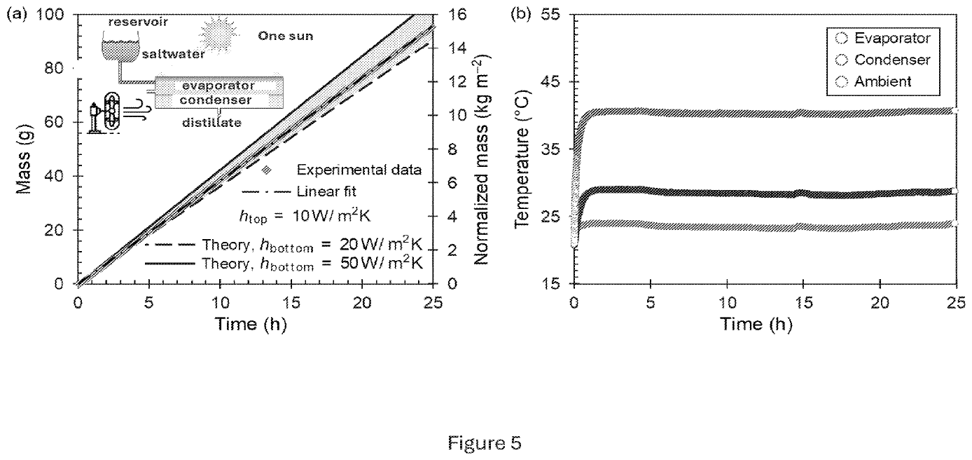

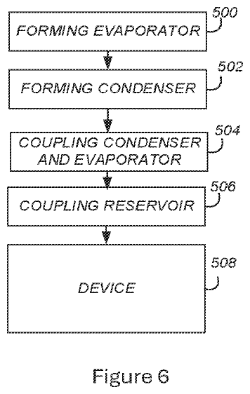

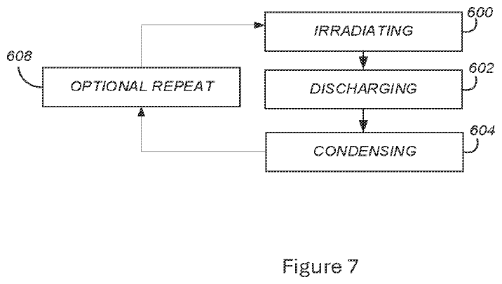

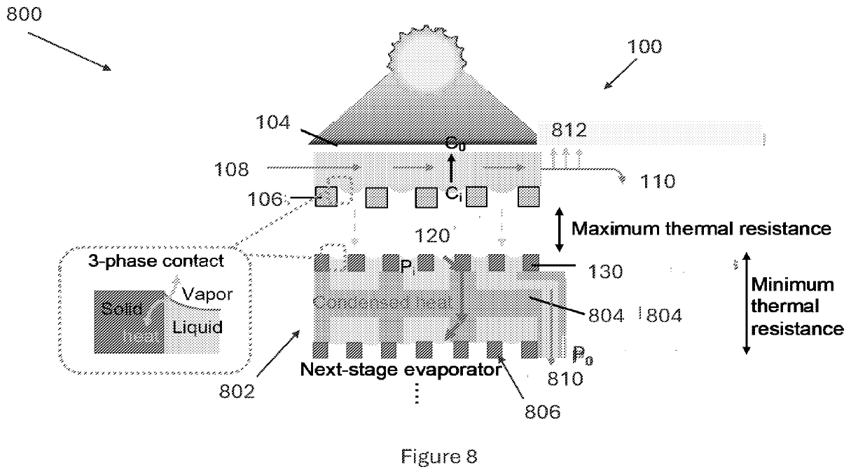

The provided modeling showcases how the thermal resistances affect the solar-to water efficiency. Specifically, enhancing the convective heat transfer coefficient on the external surface of the condenser will increase the solar-to-water efficiency. To validate this, a comprehensive full-day passive test is conducted using the passive water-driven method (FIG. 5), which involves positioning two identical 4×4 cm fans that blow room temperature air to cool the bottom surface of the condenser. An air velocity of vₐᵢᵣ=2.5 m/s was measured. It is experimentally observed that the increment in the convective heat transfer coefficient on the condenser surface has resulted in an increase in the solar-to-water efficiency to 39% (FIG. 5a), and a decrease in the evaporator and condenser temperature (FIG. 5b). The average condenser, evaporator, and ambient temperatures are ascertained to be T_{c}≈29° C., Tₑ≈40° C., and T_{amb}≈23° C., respectively. To validate the experimental result with the model, the thermophysical properties used are listed in Table S1 of (35). The convective heat transfer coefficient on the aluminum condenser can be roughly estimated as

$${h}_{bottom} = \frac{{k}_{air} \overline{Nu}}{δ} ,$$

where δ~O(10 cm) is the characteristic length, kₐᵢᵣ≈0.03 W m⁻¹ K⁻¹ is thermal conductivity of air, and [symbol] is the average Nusselt number and can be defined in terms of Prandtl (Pr=0.71 for air) and Reynolds

$$( Re = \frac{{ρ}_{ait r r} arif}{{μ}_{air}} )$$

numbers as [symbol] =0.664Re^{1/2}. By utilizing the viscosity of air as μₐᵢᵣ=1.825×10⁻⁵ Pa·s, we can calculate the convective heat transfer coefficient as h_{bottom}≈20 W m⁻² K⁻¹. Since the v3-condenser has fins that extend beyond the fans which promote convection, we used 50 and 20 W m⁻² K⁻¹ as the estimated upper and lower bounds of h_{bottom} and the results (dashed and solid lines) are shown in FIG. 5a, which agrees reasonably well with the experimental results. In addition, the model predicts temperatures of the condenser and evaporator to be T_{c}=41.37° C. and Tₑ=46.97° C., which are in relative agreement with the experimental results. Although forced air convection was used here to illustrate the influence of h_{bot0omt}, other passive methods to increase h_{bottom} such as a device floating on the ocean and radiative cooling may be employed to reduce the thermal resistance R_{bottom}.

### Multi-Stage Embodiment

FIG. 8 illustrates a multi-stage configuration desalinator device. The multi-stage configuration is designed to convert low-grade energy sources such as the sun to heat energy for vaporization of sea water. In or more embodiments, the first stage evaporator is the same as the evaporator in the embodiment in FIG. 1. In the example of FIG. 8, the first stage evaporator comprises an optically transparent thermally insulating cover 104, an inlet 108 (e.g., for salt water in), an outlet 110 (e.g., for salt water out), reuse heat for preheating 812 (e.g., a thermal coupling); and a solar absorptive, hydrophobic, microporous evaporator membrane holding a water layer consisting of a material and enclosed by the transparent cover. The condenser comprises a hydrophilic porous condenser membrane 130. The evaporator and condenser are both microporous in order to facilitate thin-film phase change which has been shown to have higher heat transfer coefficients compared to film wise and dropwise condensation. At the evaporator the latent heat exits via evaporation then re-enters the condenser via condensation. Thermally conducting metal structures transport this latent heat energy to the subsequent stages for additional evaporation and condensation to increase the distillate production. Also shown is a drain 810 through which the condensate passively drains and positioning of the next stage evaporator.

### Advantages and Improvements

An embodiment of the present disclosure reports on a salt-rejecting, passive (solar-driven) desalination device that can operate continuously to convert seawater to fresh water. The device is low cost, portable and can be installed on the roof-top for family use.

This 7-day desalination result is significant because it is the longest continuous solar desalination with passive salt rejection to date. Other reports such as one by Wang et al. report continuous solar desalination with no salt accumulation for 12 hours when using 7 wt % NaCl¹³. One report by Xu et al reports salt accumulation and rejection over 18.5 hours with illumination for 3 hours using 3.5 wt % NaCl¹⁴. In addition Ni et al. reports continuous solar vapor production from 3.5 wt % NaCl for 2000 seconds¹⁵ (~0.55 hours). These works reported these results under laboratory conditions and indicate that the result from our work is a significant and unexpected contribution to the field.

The passive, single-stage device achieved continuous sea water desalination under one sun for 1 week without efficiency decay signifying insignificant salt accumulation on the evaporator. The maximum solar to water efficiency measured on sea water is 32.9%. The majority of heat loss occurred in the evaporator due to natural and forced convection which are necessary for salt rejection. The present invention signifies an improvement in the robustness of current state of the art desalinators and presents a new architecture to further optimize passive solar desalinators.

A multi-stage configuration for this device is a modification which improves the overall efficiency of the device. The multi-stage configuration is designed to convert low-grade energy sources such as the sun to heat energy for vaporization of sea water. The evaporator and condenser are both microporous in order to facilitate thin-film phase change which has been shown to have higher heat transfer coefficients compared to film wise and dropwise condensation. At the evaporator the latent heat exits via evaporation then re-enters the condenser via condensation. Thermally conducting metal structures transport this latent heat energy to the subsequent stages for additional evaporation and condensation to increase the distillate production. FIG. 8 illustrates this process.

### Process Steps

a. Method of Fabrication

FIG. 6 is a flowchart illustrating a method of making a device (e.g., desalinator or distiller) according to one or more embodiments. The method comprises the following steps.

Block 500 represents making an evaporator by sandwiching a space between a transparent cover and a hydrophobic heat absorbing evaporator membrane; providing an inlet for receiving a liquid comprising a solute (e.g., solvent with solute dissolved therein); an outlet; and positioning a divider in the space dividing a flow of the liquid so as to maintain a bulk flow around the divider and closer to the transparent cover, and a thinner layer of the liquid on a surface of the membrane.

The criteria for the evaporator membrane are that it be hydrophobic, porous and solar absorbing (high absorption in the solar spectrum). Any materials that satisfy these criteria can be used. Example evaporator membrane materials and fabrication techniques include, but are not limited to, the solution coating of carbon particles onto a commercially available gas diffusion layer (GDL), e.g., carbon coated Teflon-infused carbon paper. Other examples of evaporator membranes include coatings, including, but are not limited to, spray coatings and brush coatings or paint. The evaporator membrane can be micro or nanoporous, for example.

In one example (used for the data obtained herein), the evaporator membrane is fabricated using two processes, membrane preparation and preparation of the coating solution. First the membrane is prepared. 0.8 g of carbon powder (Sid Richardson Carbon & Energy Co.) is dispensed into a 250 mL beaker containing 160 mL of water. 3 mL of acetic acid is added to make the carbon powder easier to attach to fibers. The mixed solution is blended using an ultrasonic cleaner (Branson Ultrasonics Bransonic™ B200) for 5 minutes. The 110 mm diameter porous carbon paper (Toray Paper 060 TGP-H-060) is added to the mixed solution to vibrate for 3 minutes in order for the carbon powders to dye the paper uniformly. We dried the carbon immersed paper at 80° C. on a hot plate for 2 hours. We repeated the membrane preparation process four times to realize the desired dark color.²⁰

According to Yiu et al., the coating solution is prepared by dispersing 1 g of PDMS containing 10% curing agent and 1 g of carbon black nanoparticles into 30 mL of hexane. The coating solution is mixed by a magnetic stir bar for 10 minutes. We immersed the membrane into the coating solution. Then, we cured the membrane on a hotplate at 80° C. for 2 hours.

The criteria for the transparent cover is that it be optically transparent in the solar spectrum.

The criteria for the divider is that it be optically transparent in the solar spectrum. In one or more examples, the transparent cover and the divider consist of mostly optically transparent materials in the solar spectrum.

Block 502 represents fabricating a condenser. The criteria for the condenser membrane is that it be hydrophilic, micro or nanoporous. It needs to be thermally conductive and release heat to the environment or be thermally coupled to a thermally conductive material which releases heat to the environment.

Block 504 represents positioning the condenser relative to the evaporator for a single stage configuration. The condenser membrane is positioned below the evaporator membrane, e.g., with a thermal separation (e.g., air gap) to maintain a temperature difference between them. For a multistage configuration, the evaporator and condenser membranes are thermally coupled to each other. The condenser membrane is situated above the evaporator membrane and thermally connected with a thermally conductive material (e.g. high thermal conductivity metal).

Block 506 represents optionally coupling a reservoir.

Block 508 represents the end result, a device (e.g., for removing a solute from a liquid). The device can be embodied in many ways including, but not limited to, the following examples.
1. A device 100, comprising:
an evaporator 102 comprising:
   a transparent cover 104;
   a hydrophobic and porous heat absorbing evaporator membrane 106;
   an inlet 108 for receiving a liquid 109 comprising a material;
   an outlet 110;
   a space 112 between the evaporator membrane and the transparent cover; and
   a divider 114 in the space dividing a flow of the liquid so as to maintain a bulk flow 116 around the divider and closer to the transparent cover, and a thinner layer 118 of the liquid on a surface of the membrane 106; wherein:
      the evaporator membrane absorbs solar radiation 107 transmitted through the transparent cover to form heat evaporating the liquid to form a vapor 120, the evaporation increases a local concentration of the material in the thinner layer of the liquid as compared to the bulk flow, and
      the divider allows mixing of the thinner layer with the bulk flow through advection, so that the material diffuses from the thinner layer to the bulk flow; and
      the outlet discharges the liquid in the thinner layer having a higher concentration of the material; and
   a condenser 122 positioned below the evaporator to receive the vapor diffused through the pores 124 in the evaporator membrane, wherein the condenser condenses the vapor to form a condensed liquid 126 (e.g., distillate).
2. The device of example 1, further comprising a reservoir 128 for the liquid, wherein the evaporator is positioned below the reservoir so that the liquid flows from the reservoir into the space under the action of gravity.
3. The device of any of the examples 1 or 2, wherein the condenser further comprises a hydrophilic microporous condenser membrane 130 comprising microstructures 132 configured for thin film condensation of the vapor through a phase change heat exchange mechanism forming a 3 phase contact region 134 between the microstructures (solid), the vapor, and the condensed liquid. “Thin-film condensation” refers to condensation (vapor-to-liquid) within a few microns (e.g., 0-10 micrometers) distance to a high-thermal-conductivity solid of the microstructures. This is realized in our device by the microstructures dimensioned and separated by spaces forming/defining the pores such that the liquid-vapor interface within each pores is close to the solid of the microstructures.
4. The device of example 3, wherein the microporous condenser membrane comprises:
a front side facing the evaporator and condensing the vapor received from the evaporator membrane; and
a backside drawing the condensed liquid to a collector 140 comprising a collector outlet 142.
5. The device of example 4, wherein the condenser further comprises the collector 140 comprising a hydrophilic, porous layer. The condensed liquid is drawn away from the front side due to negative hydrostatic pressure. There is a negative hydrostatic pressure directly below the hydrophilic, porous layer due to an opening 142 exposed to the atmosphere at the end of the collector outlet.
6. The device of example 5, wherein the collector 140 comprises a grooved structure 144 (e.g., metal pillars), or porous structure drawing flow of the condensed liquid to the condenser outlet, wherein a pore size of the collector is larger than a pore size of the microporous condenser membrane.
7. The device of any of the examples, wherein the transparent cover comprises or consists essentially of plastic (e.g. ETFE), the divider comprises plastic (e.g. PETG), and the evaporator membrane comprises a membrane comprising the pores and consists essentially of a material (e.g., carbon black nanoparticles or the carbon black nanoparticles on carbon paper).
8. The device of any of the examples 1-7, wherein the transparent cover and the divider each comprise a material with a transmittance above 80% in the solar spectrum, and the evaporator membrane comprise a porous, hydrophobic and solar absorbing material.
9. The device of any of the any of the examples 1-8, wherein microporous condenser membrane comprises a pore size in a range of tens of nanometers (nm) to one-thousand micrometers (e.g., pore size/pore diameter 10 nanometers-1000 micrometers), and/or sufficient to maintain capillary pressure that holds a liquid column for the condenser outlet.
10. The device of any of the examples 1-9, wherein the microporous condenser membrane comprises at least one of cellulose or polyester in thermal contact with a high-thermal-conductivity metal.
11. The device of example 10, wherein a majority of the microporous condenser membrane comprises the cellulose.
12. The device of any of the examples 1-11, wherein the collector comprises a metal (e.g., nickel) foam, e.g., having a pore size of at least 300 micrometers, or a porous metal or metal with machined grooves, or a conductive material (e.g., aluminum alone) thermally coupled to the condenser membrane, or the collector can comprise the condenser membrane that is thermally conductive itself.
13. The device of any of the examples 1-12, wherein the condenser is thermally coupled to a thermally conductive material (e.g., aluminum) that conducts heat away from the microporous condenser membrane, or in a multi-stage configuration, the condenser is thermally coupled to an evaporator structure comprising metal grooves and an evaporator membrane.
14. The device of example 13, wherein the thermally conductive material comprises a base 146 of the of the device (e.g., comprising a casing, a housing 148, or an enclosed chamber or enclosure), the transparent cover is on a top of the device; the collector outlet 142 is in the base; and the inlet 108 and the outlet 110 of the evaporator are a side of the enclosed chamber, and the inlet and the outlet are thermally coupled metal pipes.
15. The device of any of the examples 1-14, wherein there is a hole 149 in the housing 148 between the evaporator membrane and the condenser membrane that allows degassed air from the evaporator to escape the enclosure or housing.
16. The device of example 14 or 15 or any of the clauses 1-13, wherein a largest diameter d and thickness T (of the enclosed chamber or housing 148 or the device) are both in a range of 5 cm-1 m, or the enclosed chamber is portable or is dimensioned to fit on a rooftop of a family house.
17. The device of any of the examples 14-16, wherein apart from the inlet 108, and outlets 110, 148, and the small hole in example 15, the enclosed chamber or housing is sealed so that the device continuously converts the solar radiation to the condensed liquid comprising desalinated water in a single stage process with a conversion efficiency of at least 30% under 1 sun illumination for a period of at least 7 days.
18. The device of any of the examples 1-17, wherein the evaporator is configured to discharge the liquid having the higher concentration of the material under conditions wherein an amount of the material in the evaporator reaches equilibrium over time, as opposed to continuously increasing.
19. The device of any of the examples 1-18, wherein the material comprises one or more salts (e.g., NaCl) and/or the liquid comprising the material/salt comprises seawater or salt water.
20. The device of any of the examples 1-19, wherein the inlet 108 and the outlet 110 comprise metal (e.g., copper) tubes that are thermally connected so that exiting warm water through the outlet preheats the incoming cool water in the inlet to regenerate thermal energy, thereby increasing efficiency of the device.
21. The device of any of the examples 1-20, wherein the material comprises one or more salts (e.g., NaCl), minerals, lithium, chemicals or waste materials, or contaminants/pollutants in the liquid (e.g., water, or seawater). The discharged liquid 150 having the higher concentration of material can be waste or further treated to extract the material which may be useful or recycled for another application (e.g., lithium for batteries).
22. The device of any of the examples 1-21, wherein the material comprises a solute in the liquid, e.g. comprising a solution, or the material is a suspension in the liquid, or a component mixed in the liquid, or an evaporite.
23. The device of any of the examples 1-22, comprising a desalinator or a distiller distilling the liquid (e.g., to form the condensed liquid comprising a distillate), or a device for purifying the liquid (e.g., purifying water), or forming fresh water.
24. The device of any of the examples 1-23, wherein pores in the evaporator membrane are dimensioned to allow passage of the vapor (e.g., pore size/pore diameter 10 nanometers-1000 micrometers).
25. The device of any of the examples 1-24 in a multi-stage configuration 800, wherein the condenser 122 is thermally coupled to an evaporator structure 802 comprising metal grooves 804 and a microporous evaporator membrane 806.
26. The device of claim 25, wherein the metal grooves are positioned and dimensioned to conduct the heat most efficiently from the condenser to the evaporator.
27. The device of any of the examples 1-26, wherein the divider is a barrier positioned between the inlet and outlet to make sure the flow of liquid does not immediately exit the evaporator through the outlet, wherein there is no particular required dimension of the divider except the divider is positioned directly between the evaporator and the transparent cover to define the thickness of the thin liquid layer.
28. The device of any of the examples 1-27, wherein the three phase contact happens because of the presence of the hydrophilic porous structure of the condenser membrane dimensioned to maintain capillary pressure that holds a liquid column of the condensed liquid for the condenser outlet and so that a liquid, solid and gas are all present at each pore in the condenser membrane.
29. The device of any of the examples 1-28, wherein the liquid-vapor phase change heat flux (e.g., in the condenser membrane) is highest within a few microns (e.g., 0-10 microns) of the three phase contact line at each pore in the condenser membrane due to small evaporation and conduction thermal resistances within the few microns of the three phase contact line.
30. The device of any of the examples 1-29, wherein the bulk flow is flow that is outside of the fluid boundary layer or thinner layer, the thinner layer is a thin layer of liquid near the surface of the membrane where the material (e.g., salt) concentration is high due to that thin layer evaporating water through the membrane.
31. The device of any of the examples 1-30, wherein bulk flow is governed by interaction within the liquid itself, not walls or foreign surfaces and depends on the free stream velocity at the inlet.
32. The device of any of the examples 1-31, wherein the evaporator comprises a membrane implementing membrane distillation to flow the liquid over the membrane.
33. The device of any of the examples 1-32, wherein the evaporator membrane and the condenser membrane are configured to implement thin-film evaporation and thin-film condensation, respectively, where phase-change occurs near three-phase contact region of the evaporator membrane and the condenser membrane, to enhance evaporation and condensation efficiency, and wherein the solid (e.g., microstructures) of the condenser and evaporator membrane has high thermal conductivity such that the heat from the liquid-vapor interface can easily go to the solid or vice versa.
34. The device of any of the examples 1-33, wherein the divider prevents the liquid (e.g., salt water) flowing into the device from immediately exiting the device when the inlet and outlet are positioned close to each other/thermally coupled to facilitate heat recycling (by the discharged warm liquid in the outlet giving its heat to the colder liquid in the inlet) and therefore increase energy efficiency.
35. A device 100, comprising:
an evaporator 102 configured for evaporating liquid 109, containing a material, to form a vapor 120;
an inlet 108 to the evaporator positioned for inputting the liquid containing the material to the evaporator;
an outlet 110 from the evaporator positioned to output a portion of the liquid containing the material and remaining after the evaporating;
36. a condenser 122 positioned below the evaporator to receive the vapor, wherein the condenser comprises a porous condenser membrane 130 comprising solid portions 132 (e.g., microstructures) separated by pores 127 and configured for condensation 126 (e.g., thin film condensation) condenser positioned below the evaporator to receive the vapor, wherein the condenser comprises a porous condenser membrane comprising solid portions separated by pores and configured for condensation of the vapor on the solid portions of the vapor on the solid portions, e.g., through a phase change heat exchange mechanism forming a 3 phase contact region 134 between the solid portions, the vapor, and a condensed liquid condensed from the vapor and wherein the condensed liquid and vapor are both present in the pores in contact with the solid portions, and optionally wherein the liquid-vapor phase change heat flux (e.g., in the condenser membrane) is highest within a few microns (e.g., 0-10 microns) of the three phase contact line at each pore in the condenser membrane due to small evaporation and conduction thermal resistances within the few microns of the three phase contact line.
37. The device of clause 36, further comprising:
a transparent cover 104;
an evaporator membrane 106 configured for thin film evaporation of the liquid 109 (e.g., within 0-10 microns of the surface of the evaporator membrane) in contact with the evaporator membrane in response to absorption of solar radiation transmitted through the transparent cover, wherein the evaporator membrane comprises pores 124 dimensioned to allow passage of the vapor created by the evaporating; and
the outlet 110 positioned for discharging at least a portion of a layer of the liquid 118 in direct contact with a surface of the evaporator membrane, the layer containing a higher concentration of the material as compared to a bulk flow 116 of the liquid above the layer.
38. The device of clause 36 or 37, further comprising:
the inlet thermally coupled to the outlet and coupled to a space 112 containing the liquid between the evaporator membrane and the transparent cover; and
a barrier 114 in the space and positioned between the inlet and the outlet for preventing flow of the liquid directly from the inlet to the outlet without passing over the evaporator membrane.
39. The device of clause 37, wherein the barrier 112 comprises a divider dividing the flow of the liquid so as to maintain the bulk flow closer to the transparent cover and the thinner layer of the liquid on a surface of the membrane; so that in response to the evaporating, the thinner layer comprises a higher local concentration of the material as compared to the bulk flow,
and wherein the thinner layer mixes with the bulk flow through advection to allow diffusion of at least some of the material from the thinner layer to the bulk flow.
40. The device of any of the clauses 35-38 comprising any of the clauses 1-34/
41. The device of any of the clauses 1-39, wherein the divider is a thin slab of material whose width is defined by the thickness between the transparent cover and the evaporator membrane, the divider is approximately 60% the length or diameter of the evaporator membrane and the divider is positioned between the inlet and outlet.
42. The device of any of the clauses 1-40, wherein the evaporator membrane and/or the condenser membrane each comprise a solid comprising nanostructures or microstructures 132, 106 (e.g., a powder, particles) separated by spaces forming pores, that can be formed as powder or particles deposited on a substrate, e.g., as coatings, including, but are not limited to, spray coatings and brush coatings or paint. In one example, the evaporator membrane and the condenser membrane comprises carbon particles on a substrate, e.g., carbon-coated fiber paper.
43. The device of clause 41, wherein the nanostructures or the microstructures and the pores 127, 124 each comprise a diameter, maximum diameter, or maximum dimension D in a range of 10 nanometers-1000 micrometers (e.g., 10 nm≤D≤1000 micrometers).
44. A multi-stage system comprising a stack of a plurality of the devices of any of the clauses 1-42, wherein each of the devices comprises a different stage in the system and the collector in a previous one of the stages is thermally coupled to the evaporator in the next one of the stages.
45. The device of any of the clauses 1-44, wherein the condenser membrane comprises the solid portions comprising micro or nanostructures having a diameter, and the pores having a pore size, wherein the pore size and the diameter is in a range of ten nanometers to one-thousand micrometers, and/or sufficient to maintain capillary pressure that holds the condensed liquid in a liquid column for the condenser outlet.
46. A device, comprising:
an evaporator configured for evaporating liquid, containing a material, to form a vapor;
an inlet to the evaporator positioned for inputting the liquid containing the material to the evaporator;
an outlet from the evaporator positioned to output a portion of the liquid containing the material and remaining after the evaporating;
a condenser positioned below the evaporator to receive the vapor, wherein the condenser comprises a microporous or nanoporous condenser membrane.
47. A multi-stage system comprising a stack of a plurality of the devices of any of the clauses 1-46, wherein the collector in a previous one of the stages is thermally coupled to the evaporator in the next one of the stages.

### Method of Operation

FIG. 7 illustrates a method of continuously operating a device comprising an evaporator coupled to a condenser. The method comprises, in a single stage continuous process, the following steps.
Block 600 represents irradiating the evaporator in a presence of a liquid comprising a solute through (e.g., a transparent cover) under conditions, wherein the evaporator converts the solar radiation to heat evaporating the liquid so as to form vapor and the solute having a higher solute concentration;
Block 602 represents discharging the liquid under conditions wherein an amount of solute in the evaporator reaches equilibrium over time, as opposed to continuously increasing.
Block 604 represents condensing the vapor in the condenser to form a condensed liquid.
Block 608 represents optionally repeating steps of blocks 600-604 in a multi-stage process (2 or more times, up to n times where n is a finite integer) and transferring/transporting latent heat from the condenser in the previous stage to the evaporator in the next stage.

The method can be implemented in many ways including, but not limited to, using the device of any of the examples and clauses 1-46 described herein.

Example methods include, but are not limited to:
1. A method of distilling, comprising, in a continuous single stage process:
irradiating an evaporator in a presence of liquid comprising at least one material through a transparent cover under conditions wherein the evaporator converts the solar radiation to heat evaporating the liquid, so as to form vapor and a liquid comprising having a higher concentration of the material;
discharging the liquid comprising the higher concentration under conditions wherein an amount of material in the evaporator reaches equilibrium over time, as opposed to continuously increasing; and
condensing the vapor in the condenser to form a condensed liquid.

A method of distilling, comprising a continuous multi stage process comprising:
(a) a first stage comprising:
   irradiating a first evaporator in a presence of a first portion of liquid comprising at least one material through a transparent cover under conditions wherein the evaporator converts the solar radiation to heat evaporating the liquid, so as to form vapor and a concentrated liquid comprising a higher concentration of the material;
   discharging the concentrated liquid comprising the higher concentration under conditions wherein an amount of the material in the evaporator reaches equilibrium over time, as opposed to continuously increasing; and
   condensing the vapor in a condenser to form a condensed liquid; and
(b) one or more stages each comprising:
   transporting latent heat from the condenser of the previous stage to a subsequent evaporator structure comprising another portion of the liquid and thermally connected to the condenser, wherein the another portion of the liquid, comprising the at least one material, is evaporated in the subsequent evaporator structure so as to form a another portion of the vapor and a another portion of the concentrated liquid having a higher concentration of the material.
2. The method of clause 1, wherein each of the subsequent stages each further comprise:
discharging the other portion of the concentrated liquid comprising the higher concentration under conditions wherein an amount of the material in the evaporator structure reaches equilibrium over time, as opposed to continuously increasing; and
condensing the another portion of the vapor in a subsequent condenser to form another portion of the condensed liquid.
3. The method of clause 1 or 2, wherein the subsequent evaporator structure comprises metal grooves and a microporous evaporator membrane.
4. The method of any of the clauses 1-3, wherein the multi-stage process comprises repeating the step (b) one or more times wherein the evaporator structure in the next repeat of step (b) receives the latent heat from the condenser in the previous one of the stages.
5. The method of any of the clauses 1-4 implemented using the device of any of the clauses 1-42.
6. The method or device of any of the device clauses 1-45 or method clauses 1-6, wherein the liquid comprises salt water and the material comprises salt (e.g., NaCl), the device is a desalinator, and the liquid discharged from the outlet has a higher concentration of the salt.

### REFERENCES

The following references are incorporated by reference herein:
(1) Van der Bruggen, B. Desalination by Distillation and by Reverse Osmosis—Trends towards the Future. Membrane Technology 2003, 2003 (2), 6-9. https://doi.org/10.1016/S0958-2118(03)02018-4.
(2) Neumann, O.; Urban, A. S.; Day, J.; Lal, S.; Nordlander, P.; Halas, N. J. Solar Vapor Generation Enabled by Nanoparticles. ACS Nano 2013, 7 (1), 42-49. https://doi.org/10.1021/nn304948h.
(3) Seckler, D.; Barker, R.; Amarasinghe, U. Water Scarcity in the Twenty-First Century. Int J Water Resour Dev 1999, 15 (1-2), 29-42. https://doi.org/10.1080/07900629948916.
(4) Ghasemi, H.; Ni, G.; Marconnet, A. M.; Loomis, J.; Yerci, S.; Miljkovic, N.; Chen, G. Solar Steam Generation by Heat Localization. Nat Commun 2014, 5. https://doi.org/10.1038/ncomms5449.
(5) Zhou, L.; Tan, Y.; Wang, J.; Xu, W.; Yuan, Y.; Cai, W.; Zhu, S.; Zhu, J. 3D Self-Assembly of Aluminium Nanoparticles for Plasmon-Enhanced Solar Desalination. Nat Photonics 2016, 10 (6), 393-398. https://doi.org/10.1038/nphoton.2016.75.
(6) Tao, P.; Ni, G.; Song, C.; Shang, W.; Wu, J.; Zhu, J.; Chen, G.; Deng, T. Solar-Driven Interfacial Evaporation. Nature Energy. Nature Publishing Group Dec. 1, 2018, pp 1031-1041. https://doi.org/10.1038/s41560-018-0260-7.
(7) Ni, G.; Li, G.; Boriskina, S. V.; Li, H.; Yang, W.; Zhang, T.; Chen, G. Steam Generation under One Sun Enabled by a Floating Structure with Thermal Concentration. Nat Energy 2016, 1(9), 16126. https://doi.org/10.1038/nenergy.2016.126.
(8) Dong, X.; Si, Y.; Chen, C.; Ding, B.; Deng, H. Reed Leaves Inspired Silica Nanofibrous Aerogels with Parallel-Arranged Vessels for Salt-Resistant Solar Desalination. ACS Nano 2021, 15 (7), 12256-12266. https://doi.org/10.1021/acsnano.1c04035.
(9) Zhou, X.; Zhao, F.; Guo, Y.; Zhang, Y.; Yu, G. A Hydrogel-Based Antifouling Solar Evaporator for Highly Efficient Water Desalination. Energy Environ Sci 2018, 11 (8), 1985-1992. https://doi.org/10.1039/C8EE00567B.
(10) Zhao, F.; Zhou, X.; Shi, Y.; Qian, X.; Alexander, M.; Zhao, X.; Mendez, S.; Yang, R.; Qu, L.; Yu, G. Highly Efficient Solar Vapour Generation via Hierarchically Nanostructured Gels. Nat Nanotechnol 2018, 13 (6), 489-495. https://doi.org/10.1038/s41565-018-0097-z.
(11) Menon, A. K.; Haechler, I.; Kaur, S.; Lubner, S.; Prasher, R. S. Enhanced Solar Evaporation Using a Photo-Thermal Umbrella for Wastewater Management. Nat Sustain 2020, 3 (2), 144-151. https://doi.org/10.1038/s41893-019-0445-5.
(12) Li, X.; Ni, G.; Cooper, T.; Xu, N.; Li, J.; Zhou, L.; Hu, X.; Zhu, B.; Yao, P.; Zhu, J. Measuring Conversion Efficiency of Solar Vapor Generation. Joule 2019, 3 (8), 1798-1803. https://doi.org/10.1016/j.joule.2019.06.009.
(13) Wang, F.; Xu, N.; Zhao, W.; Zhou, L.; Zhu, P.; Wang, X.; Zhu, B.; Zhu, J. A High-Performing Single-Stage Invert-Structured Solar Water Purifier through Enhanced Absorption and Condensation. Joule 2021, 5 (6), 1602-1612. https://doi.org/10.1016/j.joule.2021.04.009.
(14) Xu, Z.; Zhang, L.; Zhao, L.; Li, B.; Bhatia, B.; Wang, C.; Wilke, K. L.; Song, Y.; Labban, O.; Lienhard, J. H.; Wang, R.; Wang, E. N. Ultrahigh-Efficiency Desalination: Via a Thermally-Localized Multistage Solar Still. Energy Environ Sci 2020, 13 (3), 830-839. https://doi.org/10.1039/c9ee04122b.
(15) Ni, G.; Zandavi, S. H.; Javid, S. M.; Boriskina, S. V.; Cooper, T. A.; Chen, G. A Salt-Rejecting Floating Solar Still for Low-Cost Desalination. Energy Environ Sci 2018, 11 (6), 1510-1519. https://doi.org/10.1039/C8EE00220G.
(16) Dongare, P. D.; Alabastri, A.; Pedersen, S.; Zodrow, K. R.; Hogan, N. J.; Neumann, O.; Wud, J.; Wang, T.; Deshmukh, A.; Elimelech, M.; Li, Q.; Nordlander, P.; Halas, N. J. Nanophotonics-Enabled Solar Membrane Distillation for off-Grid Water Purification. Proc Natl Acad Sci USA 2017, 114 (27), 6936-6941. https://doi.org/10.1073/pnas.1701835114.
(17) Xue, G.; Chen, Q.; Lin, S.; Duan, J.; Yang, P.; Liu, K.; Li, J.; Zhou, J. Highly Efficient Water Harvesting with Optimized Solar Thermal Membrane Distillation Device. Global Challenges 2018, 2 (5-6), 1800001. https://doi.org/10.1002/gch2.201800001.
(18) Chiavazzo, E.; Morciano, M.; Viglino, F.; Fasano, M.; Asinari, P. Passive Solar High-Yield Seawater Desalination by Modular and Low-Cost Distillation. Nat Sustain 2018, 1 (12), 763-772. https://doi.org/10.1038/s41893-018-0186-x.
(19) Zhang, L.; Li, X.; Zhong, Y.; Leroy, A.; Xu, Z.; Zhao, L.; Wang, E. N. Highly Efficient and Salt Rejecting Solar Evaporation via a Wick-Free Confined Water Layer. Nat Commun 2022, 13 (1). https://doi.org/10.1038/s41467-022-28457-8.
(20) Huang, L.; Jiang, H.; Wang, Y.; Ouyang, Z.; Wang, W.; Yang, B.; Liu, H.; Hu, X. Enhanced Water Yield of Solar Desalination by Thermal Concentrated Multistage Distiller. Desalination 2020, 477, 114260. https://doi.org/10.1016/j.desal.2019.114260.
(21) Toray Carbon Paper 060, Wet Proofed. https://www.fuelcellstore.com/fuel-cell-components/gas-diffusion-layers/carbon-paper/toray-carbon-paper/toray-carbon-paper-060.
(22) TechniCloth® TX609 Nonwoven Dry Cleanroom Wipers, Non-Sterile. https://www.texwipe.com/technicloth-tx609.
(23) Rachid, A.; Goren, A.; Becerra, V.; Radulovic, J.; Khanna, S. Fundamentals of Solar Energy; 2023; pp 1-15. https://doi.org/10.1007/978-3-031-20830-0_1.
(24) Pinho, S. P.; Macedo, E. A. Solubility of NaCl, NaBr, and KCl in Water, Methanol, Ethanol, and Their Mixed Solvents. J Chem Eng Data 2005, 50 (1), 29-32. https://doi.org/10.1021/je049922y.
(25) Zhu, L.; Gao, M.; Peh, C. K. N.; Ho, G. W. Recent Progress in Solar-Driven Interfacial Water Evaporation: Advanced Designs and Applications. Nano Energy 2019, 57, 507-518. https://doi.org/10.1016/j.nanoen.2018.12.046.
(26) Zhang, P.; Li, J.; Lv, L.; Zhao, Y.; Qu, L. Vertically Aligned Graphene Sheets Membrane for Highly Efficient Solar Thermal Generation of Clean Water. ACS Nano 2017, 11 (5), 5087-5093. https://doi.org/10.1021/acsnano.7b01965.
(27) Liu, Z.; Song, H.; Ji, D.; Li, C.; Cheney, A.; Liu, Y.; Zhang, N.; Zeng, X.; Chen, B.; Gao, J.; Li, Y.; Liu, X.; Aga, D.; Jiang, S.; Yu, Z.; Gan, Q. Extremely Cost-Effective and Efficient Solar Vapor Generation under Nonconcentrated Illumination Using Thermally Isolated Black Paper. Global Challenges 2017, 1 (2), 1600003. https://doi.org/10.1002/gch2.201600003.
(28) Li, X.; Xie, W.; Zhu, J. Interfacial Solar Steam/Vapor Generation for Heating and Cooling. Advanced Science 2022, 9 (6), 2104181. https://doi.org/10.1002/advs.202104181.
(29) Zhou, P.; Zhu, Q.; Sun, X.; Liu, L.; Cai, Z.; Xu, J. Recent Advances in MXene-Based Membrane for Solar-Driven Interfacial Evaporation Desalination. Chemical Engineering Journal 2023, 464, 142508. https://doi.org/10.1016/j.cej.2023.142508.
(30). S.; Sinhamahapatra, A.; Kumar, A. Review of the Progress of Solar-Driven Interfacial Water Evaporation (SIWE) toward a Practical Approach. Energy Advances 2023. https://doi.org/10.1039/D3YA00028A.
(31) Wang, J.; Wang, R.; Geng, Y.; Li, Y.; Li, J.; Qiu, J.; Li, M. Activated Pulverized Coal Membrane for Effective Solar-Driven Interfacial Evaporation and Desalination. Chem Eng Sci 2023, 265, 118248. https://doi.org/10.1016/j.ces.2022.118248.
(32) Wang, Y.; Li, W.; Wei, Y.; Chen, Q. Recyclable Monolithic Vitrimer Foam for High-Efficiency Solar-Driven Interfacial Evaporation. ACS Appl Mater Interfaces 2023. https://doi.org/10.1021/acsami.2c23197.
(33) Water Evaporation. ACS Appl Mater Interfaces 2022, 14 (17), 19409-19418. https://doi.org/10.1021/acsami.2c01359.
(34) Liu, Y.; Chen, J.; Guo, D.; Cao, M.; Jiang, L. Floatable, Self-Cleaning, and Carbon-Black-Based Superhydrophobic Gauze for the Solar Evaporation Enhancement at the Air-Water Interface. ACS Appl Mater Interfaces 2015, 7 (24), 13645-13652. https://doi.org/10.1021/acsami.5b03435.
(35) Salt-rejecting continuous passive solar thermal desalination via convective flow and thin-film condensation by Patrick I. Babb, U, Yangying Zhu et. al. Volume 4, Issue 12, 20 Dec. 2023, 101682.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A device, comprising:
an evaporator configured for evaporating liquid, containing a material, to form a vapor;
an inlet to the evaporator positioned for inputting the liquid containing the material to the evaporator;
an outlet from the evaporator positioned to output a portion of the liquid containing the material and remaining after the evaporating;
a condenser positioned below the evaporator to receive the vapor, wherein the condenser comprises a porous condenser membrane comprising solid portions separated by pores and configured for condensation of the vapor on the solid portions through a phase change heat exchange mechanism forming a 3 phase contact region between the solid portions, the vapor, and a condensed liquid condensed from the vapor and wherein the condensed liquid and vapor are both present in the pores in contact with the solid portions.

2. The device of claim 1, further comprising:
a transparent cover;
an evaporator membrane configured for thin film evaporation of the liquid in contact with the evaporator membrane in response to absorption of solar radiation transmitted through the transparent cover, wherein the evaporator membrane comprises pores dimensioned to allow passage of the vapor created by the evaporating; and
the outlet positioned for discharging at least a portion of a layer of the liquid in direct contact with a surface of the evaporator membrane, the layer containing a higher concentration of the material as compared to a bulk flow of the liquid above the layer.

3. The device of claim 2, further comprising:
the inlet thermally coupled to the outlet and coupled to a space containing the liquid between the evaporator membrane and the transparent cover; and
a barrier in the space and positioned between the inlet and the outlet for preventing flow of the liquid directly from the inlet to the outlet without passing over the evaporator membrane.

4. The device of claim 1, wherein the barrier comprises a divider dividing the flow of the liquid so as to maintain the bulk flow closer to the transparent cover and the thinner layer of the liquid on a surface of the membrane; so that in response to the evaporating, the thinner layer comprises a higher local concentration of the material as compared to the bulk flow,
and wherein the thinner layer mixes with the bulk flow through advection to allow diffusion of at least some of the material from the thinner layer to the bulk flow.

5. The device of claim 1, wherein the condenser further comprises a condenser outlet and the porous condenser membrane comprises:
a front side facing the evaporator and condensing the vapor received from the evaporator; and
a backside drawing the condensed liquid to a collector outlet.

6. The device of claim 5, wherein:
the condenser membrane comprises a hydrophilic and microporous layer, and
the condensed liquid is drawn away from the front side due to a negative hydrostatic pressure directly below the condenser membrane due to an opening exposed to the atmosphere at the end of the collector outlet.

7. The device of claim 5, wherein the collector comprises a collector structure comprising grooves or a porous structure drawing a flow of the condensed liquid to the condenser outlet, wherein a pore size or groove size of the collector structure is larger than a pore size of the condenser membrane.

8. The device of claim 3, wherein the transparent cover and the barrier each comprise a material with a transmittance above 80% for electromagnetic radiation in a solar spectrum, and the evaporator membrane comprises a porous, hydrophobic and solar absorbing material.

9. The device of claim 1, wherein the condenser membrane comprises the solid portions comprising micro or nanostructures having a diameter, and the pores having a pore size, wherein the pore size and the diameter is in a range of ten nanometers to one-thousand micrometers, and/or sufficient to maintain capillary pressure that holds the condensed liquid in a liquid column for the condenser outlet.

10. The device of claim 1, wherein the collector comprises a porous metal or metal with machined grooves, or a conductive material thermally coupled to the condenser membrane.

11. The device of claim 1, wherein the condenser is thermally coupled to a thermally conductive material that conducts heat away from the condenser membrane or in a multi-stage configuration, the condenser is thermally coupled to an evaporator structure comprising metal grooves and an evaporator membrane.

12. The device of claim 11, further comprising a housing wherein the thermally conductive material comprises a base of the housing, a transparent cover is on a top of the housing; a collector outlet is in the base; the inlet and the outlet of the evaporator are on a side of the housing, and the inlet and the outlet are thermally coupled metal pipes or tubes in order to recycle the heat from the outlet to the inlet.

13. The device of claim 12, further comprising a hole in the housing between the evaporator membrane and the condenser membrane that allows degassed air from the evaporator to escape.

14. The device of claim 1, wherein a largest diameter and thickness of the device are both in a range of 5 cm-1 m, or the device is portable or is dimensioned to fit on a rooftop of a family house.

15. The device of claim 1, wherein apart from the inlet, the outlets, and a small hole in the housing, the housing is sealed so that the device continuously converts solar radiation evaporating the liquid to form the condensed liquid comprising water in a single stage process with a conversion efficiency of at least 30% under 1 sun illumination for a period of at least 7 days.

16. The device of claim 1, wherein the evaporator is configured to discharge the liquid having the higher concentration of the material comprising non evaporated components under conditions wherein an amount of the non evaporated components in the evaporator reaches equilibrium over time, as opposed to continuously increasing.

17. (canceled)

18. (canceled)

19. (canceled)

20. (canceled)

21. (canceled)

22. (canceled)

23. The method of claim 1 or the device of claim 1 wherein the liquid comprises salt water and the material comprises salt, the device is a desalinator, and the liquid discharged from the outlet has a higher concentration of the salt.

24. (canceled)

25. A multi-stage system comprising a stack of a plurality of the devices of claim 1, wherein the collector in a previous one of the stages is thermally coupled to the evaporator in the next one of the stages.
